(19) United States
(12) Patent Application Publication
(10) Pub. No.: US 2015/0019800 A1
(43) Pub. Date: Jan. 15, 2015

(54) Firmware Package to Modify Active Firmware

(71) Applicants: Eric A Ramirez, Houston, TX (US); Cemil J Ayvaz, Houston, TX (US); Lee A Preimesberger, Houston, TX (US)

(72) Inventors: Eric A Ramirez, Houston, TX (US); Cemil J Ayvaz, Houston, TX (US); Lee A Preimesberger, Houston, TX (US)

(73) Assignee: Hewlett-Packard Development Company L.P., Fort Collins, CO (US)

(21) Appl. No.: 14/379,747

(22) PCT Filed: Feb. 23, 2012
(86) PCT No.: PCT/US2012/026270

§ 371 Date: Aug. 19, 2014

(51) Int. Cl. G06F 21/57

(52) U.S. Cl. CPC G06F 21/572; G06F 2221/031
USPC 711/103

(57) ABSTRACT

A computing device includes a non-volatile storage component with a first portion to include active firmware for components of the computing device and a second portion to include a firmware package to modify the active firmware. The computing device installs firmware from the firmware package and determines if the firmware is successfully installed before proceeding to install subsequent firmware from the firmware package. The computing device uninstalls the firmware package to restore the active firmware if a firmware from the firmware package fails to install.

### BACKGROUND

When updating firmware on a computing device, a user can initially access a first firmware file and proceed to update a first firmware of the computing device. Once the first firmware has been updated, the user can repeat this process for each additional firmware of the computing device to update. In some instances, a firmware may be installed incorrectly and the user may not be notified of the failed installation. As a result, the computing device can be rendered unstable or unusable. Additionally, the user may have to identify previously used firmware and proceed to install the previously used firmware leading to time consumption and an unpleasant experience for the user.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a computing device with a non-volatile storage component according to an example.

FIG. 2 illustrates a computing device receiving a firmware package according to an example.

FIG. 3 illustrates a block diagram computing device modifying active firmware with a firmware package according to an example.

FIG. 4 illustrates a block diagram computing device uninstalling a firmware package to restore active firmware according to an example.

FIG. 5 is a flow chart illustrating a method for managing a computing device according to an example.

FIG. 6 is a flow chart illustrating a method for managing a computing device according to another example.

### DETAILED DESCRIPTION

A computing device can include a non-volatile storage component with a first portion and a second portion to separate active firmware corresponding to components of the computing device from a firmware package used to modify the active firmware. The computing device installs each firmware from the firmware package following a first order and determines if each firmware is successfully installed before proceeding to install subsequent firmware from the firmware package. The computing device can keep a status log of each firmware installation to identify successful and/or unsuccessful installations.

If each of the firmware from the firmware package is successfully installed, the active firmware of the computing device can be successfully modified. If the computing device detects an unsuccessful firmware install, the computing device can cease installation of any additional firmware from the package and proceed to uninstall each firmware from the firmware package following a second direction, opposite to the first direction, to restore the active firmware. Each previously installed firmware from the firmware package can be uninstalled one-by-one to rollback and restore the active firmware of the computing device. Uninstalling a firmware from the firmware package can include the computing device reinstalling a master firmware or last know stable firmware for a corresponding component to restore the computing device to a last known stable state.

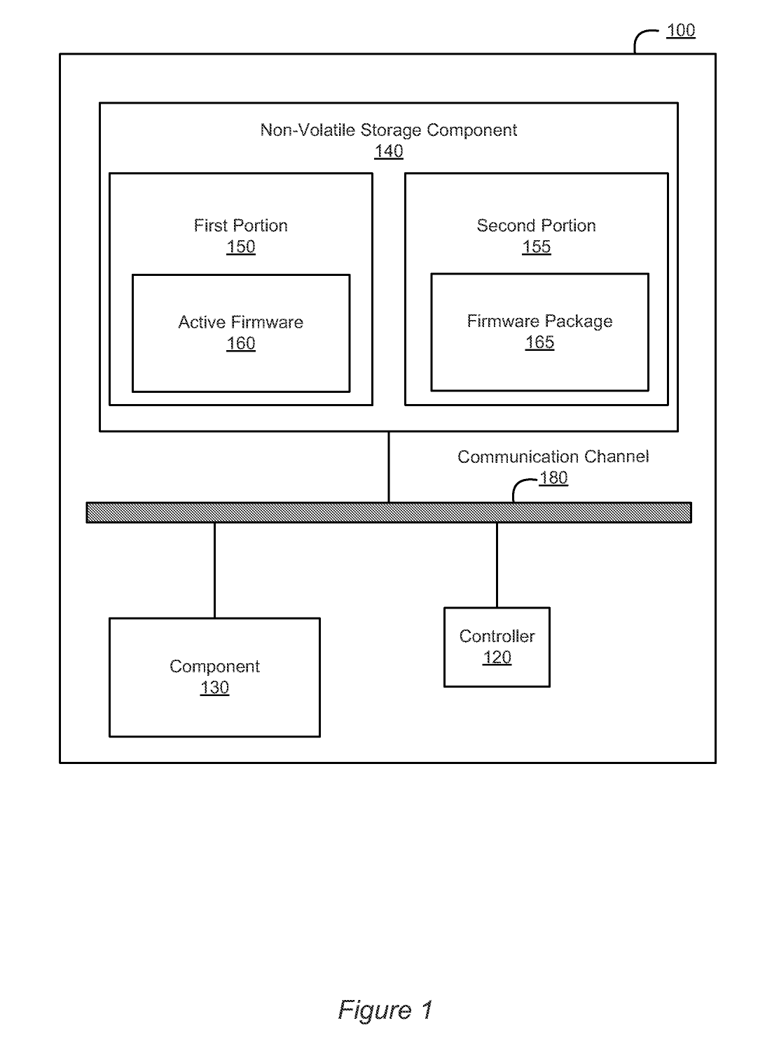

FIG. 1 illustrates a computing device 100 with a non-volatile storage component 140 according to an example. The computing device 100 can be a laptop, a notebook, a tablet, a netbook, an all-in-one system, a desktop, a workstation, and/or a server. In another embodiment, the computing device 100 can be a cellular device, a PDA (Personal Digital Assistant), and/or an E (Electronic)-Reader, and/or any additional computing device with a non-volatile storage component 140.

As illustrated in FIG. 1, the computing device 100 includes a controller 120, a non-volatile storage component 140, at least one component 130, and a communication channel 150 for the computing device 100 and/or one or more components of the computing device 100 to communicate with one another. In one embodiment, the computing device 100 additionally includes a component application stored on a non-transitory computer readable memory coupled to the computing device 100. The component application is an application which can be utilized in conjunction with the controller 120 to manage the computing device 100.

The non-volatile storage component 140 can include flash memory, a storage drive, such as a hard drive or optical drive, and/or any additional non-volatile storage device which can include a first portion 150 and a second portion 155. The first portion 150 is a space or area of the non-volatile storage component 140 which includes active firmware 160 for components 130 of the computing device 100. For the purposes of this application, active firmware 160 includes drivers and/or software which are being utilized by the computing device 100 to manage and operate the components 130. In one embodiment, the active firmware 160 also includes drivers and/or software being utilized by an embedded operating system of the computing device 200. The components 130 can include a video, an audio, a communication component, and/or any additional component utilized by the computing device 100.

The second portion 155 includes a space or area of the non-volatile storage component 140 which is separate from the first portion 140 and includes a firmware package 165. The firmware package 165 includes installable firmware for the components 130 of the computing device 100. In one embodiment, the firmware package 165 includes an installable firmware for each component 130 of the computing device 100. By installing a firmware from the firmware package 165, a corresponding active firmware 160 of the computing device 100 can be modified. The firmware package 165 can be received by the computing device 100 from a second computing device coupled to the computing device 100.

The controller 120 and/or the component application can initiate a request to modify the active firmware 160 with the firmware package 165. The controller 120 and/or the component application can retrieve the firmware package 165 from the second portion 155 and proceed to install each firmware from the firmware package 165 sequentially following a first direction. For example, a first firmware can be installed, followed by any subsequent firmware, until the last firmware is installed.

After each firmware from the firmware package 165 is installed, the controller 120 and/or the component application can determine if the firmware was successfully installed before proceeding to install the subsequent firmware. When determining whether the firmware was successfully installed, the controller 120 and/or the component application can determine if the corresponding active firmware 160 was successfully modified. In one embodiment, the controller 120 and/or the component application can query the component 130 which is using the modified active firmware 165. If a response is received, the corresponding active firmware 160 was successfully modified and the firmware was successfully installed. In another embodiment, the controller 120 and/or the component application can run a diagnostic test on the component 130 to determine if the component 130 is operating correctly with the modified active firmware 165.

If the component 130 does not respond to the query or fails the diagnostic test, the controller 120 and/or the component application can determine that the corresponding active firm 160 was not successfully modified and the firmware did not successfully install. If a firmware from the firmware package 165 fails to install, the controller 120 and/or the component application can proceed to uninstall the firmware package 165 following a second direct, which is opposite the first direction, to restore the active firmware 160 of the computing device 200.

The controller 120 and/or the component application can cease installation of any additional firmware from the firmware package 165 and proceed to sequentially roll back previous firmware installations from the firmware package 165. When rolling back previous firmware installations, the controller 120 and/or the component application identify a last installed firmware and each preceding firmware which was installed from the firmware package 165. The controller 120 and/or the component application can then proceed to uninstall the last installed firmware, followed by each preceding firmware which was installed from the firmware package 165, until each firmware from the firmware package 165 is uninstalled.

When uninstalling firmware from the firmware package 165, the controller 120 and/or the component application can reinstall a master firmware of the corresponding component 130. The master firmware can be stored on the non-volatile storage component 140. The master firmware corresponds to backup firmware for components 130 of the computing device 100. For each firmware uninstalled from the firmware package 165, the controller 120 and/or the component application can reinstall drivers and/or software from the master firmware for the corresponding components 130. In one embodiment, the controller 120 and/or the component application can reinstall the master firmware of every component 130 of the computing device 100.

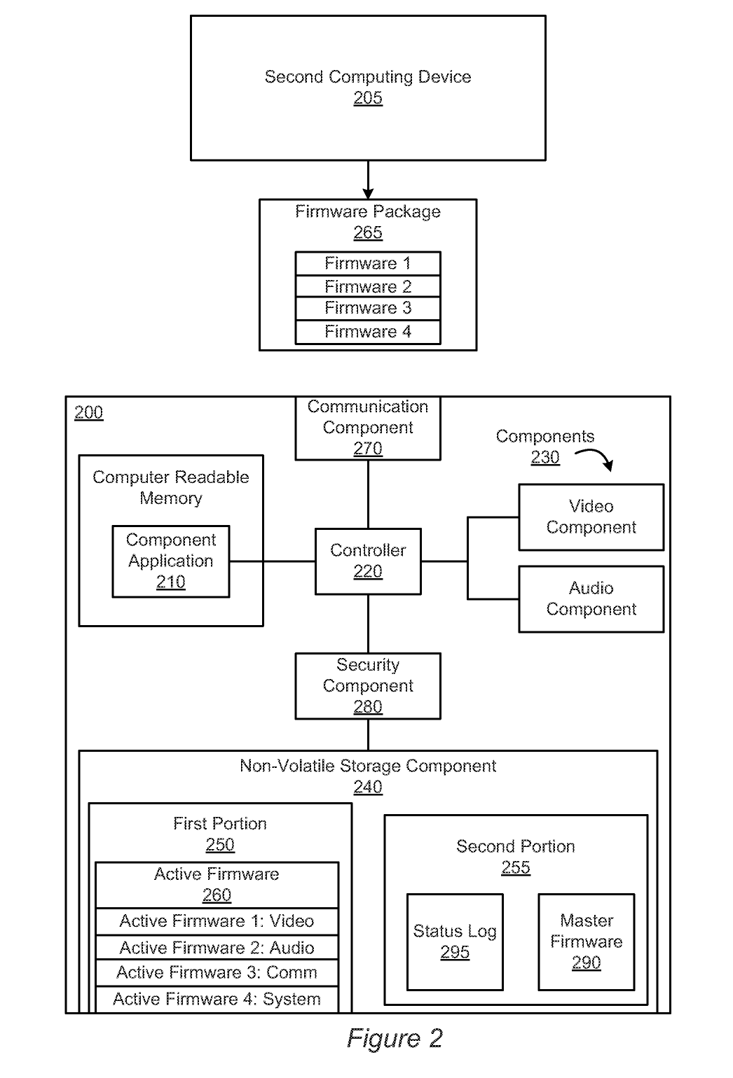

FIG. 2 illustrates a computing device 200 receiving a firmware package 265 according to examples. The computing device 200 can receive the firmware package 265 from a second computing device 205. Similar to the computing device 200, the second computing device 205 can be a laptop, a notebook, a tablet, a netbook, an all-in-one system, a desktop, a workstation, a server, a portable computing device, and/or any additional computing device which can transmit the firmware package 265 to the computing device 200.

As shown in FIG. 2, the firmware package 265 can include installable firmware to modify active firmware 260 of the computing device 200. The firmware package 265 can include firmware for one or more components of the computing device 200. In one embodiment, the firmware package 265 also includes firmware for an embedded operating system of the computing device 200. The firmware can include drivers and/or software for a corresponding component and/or an embedded operating system of the computing device 200.

As noted above, a component of the computing device 200 can include a communication component 270, a video component, an audio component, and/or a security component 280. In other embodiments, a component can be any additional hardware or software component of the computing device 200 which can have corresponding active firmware 260. The computing device 200 can receive the firmware package 265 as a file or data packet from the second computing device 205 with the communication component 270. The communication component 270 is hardware component of the computing device 200 to receive and/or transmit data between the computing device 200 and the second computing device 205. In one embodiment, the communication component 270 can include a network interface component, a wireless radio device, a Bluetooth device, and/or an infrared device.

In response to the computing device 200 receiving the firmware package 265, the security component 280 can authenticate the firmware package 265. The security component 280 is a hardware and/or software component of the computing device 200, such as a trusted platform module and/or a lights out management module, which can authenticate the firmware package 265. The security component 280 can authenticate the firmware package 265 by validating a signature of the firmware package 265 and/or by validating an identify of the second computing device 200. In one embodiment, the security component 280 can include a white list of authorized signatures of the firmware package 265 and/or of authorized identities of the second computing device 205. The security component 280 can access the white list when determining whether the firmware package 265 is authenticated.

If the firmware package 265 is successfully authenticated, the firmware package 265 can be stored on a second portion 255 of a nonvolatile storage component 240. As noted above, the non-volatile storage component 240 is a hardware storage device which includes a first portion 250 to include active firmware 260 for the components of the computing device 200 and a second portion 255 to store the firmware package 265. The non-volatile storage component 240 can include flash memory, a hard drive, an optical drive, and/or any additional hardware storage device which includes non-volatile memory.

In one embodiment, as shown in FIG. 2, the second portion 255 additionally includes a status log 295 and master firmware 290 for components of the computing device 200. For the purposes of this application, the status log 295 can be a file, a list, and/or a table which keeps a status of each corresponding active firmware 260 of the computing device 200. In one embodiment, the status log 295 can be an XML (extensible markup language) file or a SQL (structured query language data) file. The master firmware 290 corresponds to backup firmware for components of the computing device 200. In one embodiment, the master firmware 290 includes a last known stable firmware for the components of the computing device 200. In another embodiment, the master firmware 290 includes a copy of all of the active firmware 260 of the computing device 200.

In one embodiment, the security component 280 can hide the second portion 255 and content on the second portion 255 from the controller 220 and/or the component application 210. When hiding the second portion 255, the security component 280 can disable a processor, controller, and/or firmware used to control and manage the second portion 255, such that the second portion 255 is not visible to the controller 220 and/or the component application 210. As a result, the firmware package 265, the master firmware 290, the status log 295, and/or any additional content can be protected from malicious programs or unauthorized users. The security component 280 can continue to hide the second portion 255 from the controller 220 and/or the component application 210 until the controller 220 and/or the component application 210 initiate a firmware update process.

For the purposes of this application, the component application 210 can be a firmware embedded onto one or more components of the computing device 200. In another embodiment, the component application 210 can be an application accessible from a non-volatile computer readable memory of the computing device. The computer readable memory is a tangible apparatus that contains, stores, communicates, or transports the application for use by or in connection with the device. In one embodiment, the computer readable memory is a hard drive, a compact disc, a flash disk, a network drive or any other form of tangible apparatus coupled to the computing device.

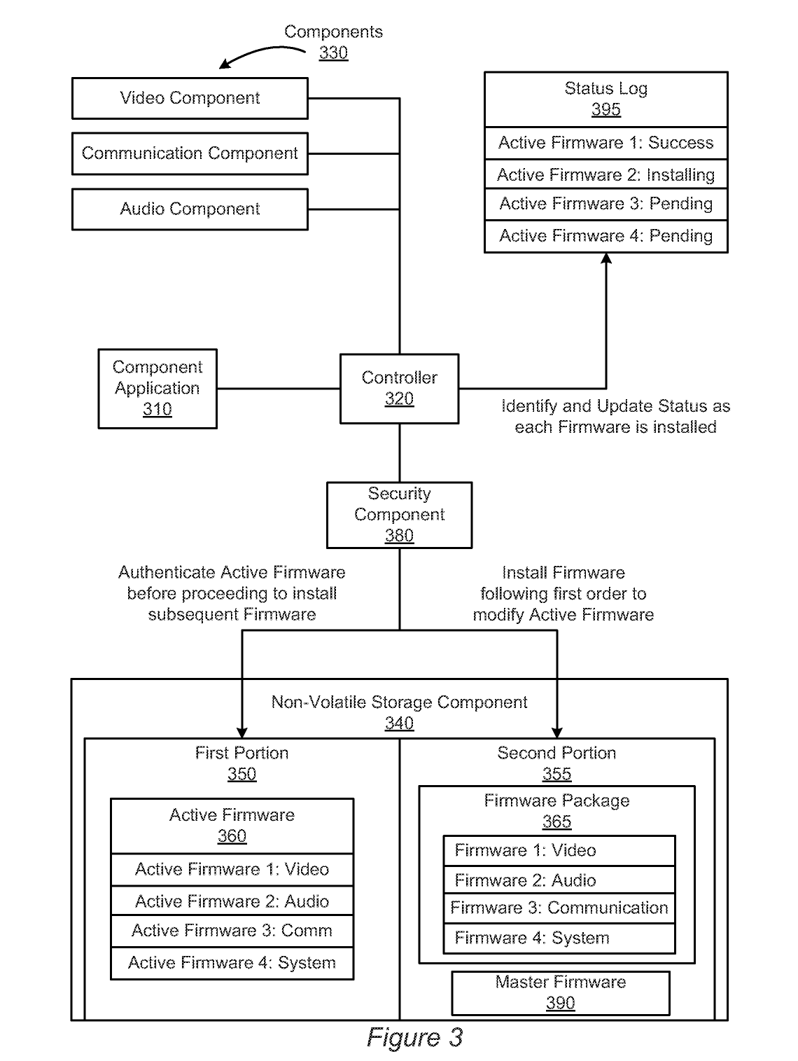

FIG. 3 illustrates a block diagram of a computing device modifying active firmware 360 with a firmware package 365 according to an example. In one embodiment, the controller 320 and/or the component application 310 can initiate a request to launch a firmware update process. The request can identify a version or serial number associated with the firmware package 365. A security component 380 can authenticate the request by determining whether the version or serial number listed by the controller 320 and/or the component application 310 match information of the firmware package 365 included within the second portion 355 of the non-volatile storage component 340. In one embodiment, the security component 380 additionally authenticates the firmware package 365 when determining whether to grant access to the firmware package 365.

If the request and the firmware package 365 are authenticated, the security component 380 can allow access to the firmware package 365 and other content included in the second portion 355. The controller 320 and/or the component application 310 can proceed to access the firmware package 365 and proceed to install each firmware from the firmware package 365. In one embodiment, the controller 320 and/or the component application 310 additionally access a status log 395 from the second portion 355 to identify a status of each active firmware on the computing device.

Before installing any firmware from the firmware package 365, the controller 320 and/or the component application 310 can reset the status of each active firmware 360 on the status log 395. In one embodiment, resetting the status of each active firmware 360 on the status log 395 includes the controller 320 and/or the component application 310 accessing the corresponding master firmware 390 from the second portion 355 and installing the corresponding master firmware 390 to reset a state of each active firmware 360. In another embodiment, the controller 320 and/or the component application 310 can additionally rollback the embedded operating system of the computing device with a master version of the embedded operating system included with the master firmware 390.

Once the status of each active firmware 365 and/or the embedded operating system have been reset, the controller 320 and/or the component application 310 proceed to install the firmware package 365 following a first order. The first order can include the controller 320 and/or the component application 310 accessing and installing each firmware from the firmware package 365 one by one and following a first to last order. In another embodiment, the first order can include accessing and installing each firmware one by one following a last to first order. After each firmware is installed, the controller 320 and/or the component application 310 can determine whether the corresponding active firmware was successfully modified.

As shown in the present embodiment, the controller 320 and/or the component application 310 can install Firmware 1: Video and determine whether Active Firmware 1: Video was successfully modified, before proceeding to install Firmware 2: Audio and determining whether Active Firmware 2: Audio was successfully modified, and subsequently Firmware 3: Communication and Firmware 4: System. When installing a firmware, the controller 320 and/or the component application 310 overwrite any drivers and/or software of the active firmware 365 with the drivers and/or software from the firmware.

When determining whether the corresponding active firmware 365 is successfully modified, the controller 320 and/or the component application 310 can query the modified active firmware 365 for a response or run a diagnostic on the corresponding component using the modified active firmware 365 to determine whether the corresponding component 330 is operating correctly. If the modified active firmware 365 responds to the query or the corresponding component 330 passes the diagnostic test, the active firmware 365 is determined to be successfully modified.

The controller 320 and/or the component application 310 can also update the status log 395 to indicate that the corresponding active firmware 360 was successfully modified. In one embodiment, if each active firmware 360 on the computing device is successfully modified, the controller 320 and/or the component application 310 can update the status log 395 to indicate that all of the active firmware was successfully modified. Additionally, the controller 320 and/or the component application 310 can overwrite the master firmware 360 on the second portion 355 with the modified active firmware 360.

If the modified active firmware 365 does not respond to the query or the corresponding component 330 does not passes the diagnostic test, the controller 320 and/or the component application 310 determine that the active firmware 365 was not successfully modified and the status log 395 can be updated to indicate that the corresponding active firmware 360 was not successfully modified. If the status log 395 indicates that any active firmware was not successfully modified, the controller 320 and/or the component application 310 cease installation of any additional firmware from the firmware package 365 and proceed to uninstall the firmware package 365 following a second order, opposite to the first order, to restore the active firmware 360.

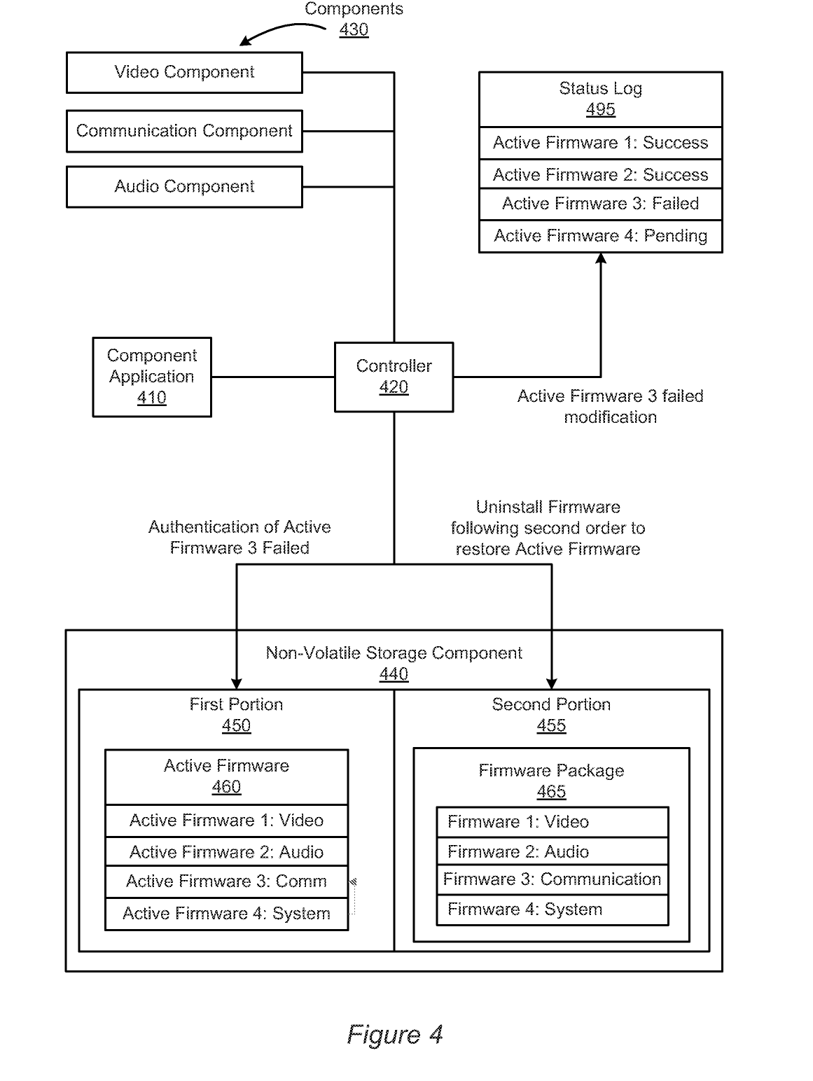

FIG. 4 illustrates a block diagram computing device uninstalling a firmware package 465 to restore active firmware according to an example. As shown in the present embodiment, the controller 420 and/or the component application 410 can determine from the status log 495 that Firmware 3 was not successfully installed and Active Firmware 3 was not successfully modified. In response, the controller 420 and/or the component application 410 proceed to uninstall the firmware package 465 following a second order.

The controller 420 and/or the component application 410 proceed to uninstall the most recently installed firmware, Firmware 3: Communication. In one embodiment, uninstalling a firmware includes the controller 420 and/or the component application 410 accessing a master firmware from the second portion and installing the master firmware to restore the active firmware. For example, the controller 420 and/or the component application 410 can access master firmware for Active Firmware 3 and proceed to install the drivers and/or software of the master firmware to restore Active Firmware 3. Once Active Firmware 3 has been restored, the controller 420 and/or the component application 410 can proceed to uninstall Firmware 2: Audio and restore Active Firmware 2 with the master firmware. Once Active Firmware 2 has been restored, the controller 420 and/or the component application 410 can then uninstall Firmware 1: Video and proceed to restore Active Firmware 1 with the master firmware.

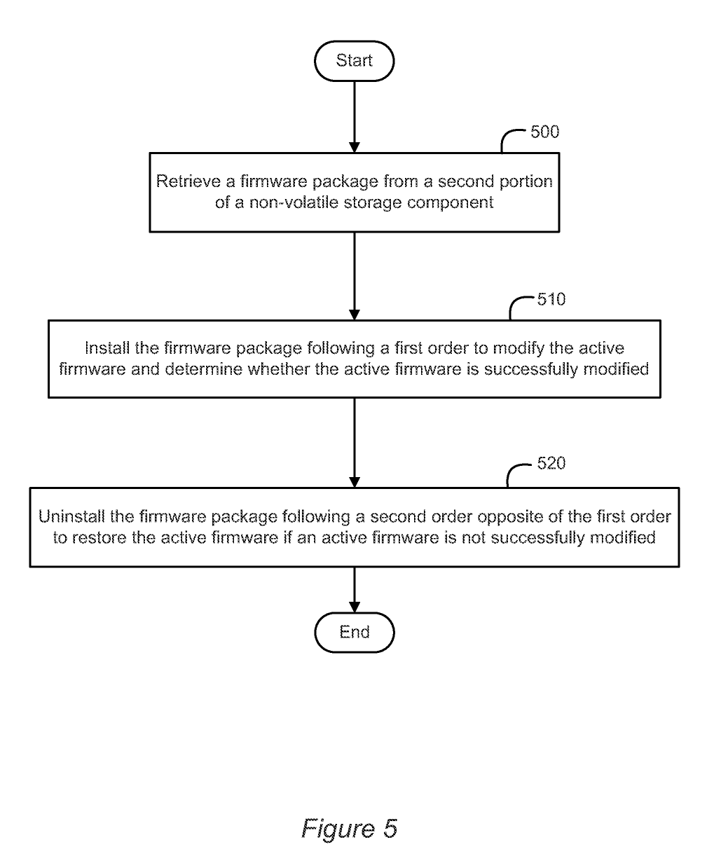

FIG. 5 is a flow chart illustrating a method for managing a computing device according to an example. As noted above, a component application can be utilized independently and/or in conjunction with the controller to manage the computing device. The controller and/or the component application can initially retrieve a firmware package from a second portion of a non-volatile storage component at 500. The firmware package can be received from a second computing device, such as a server. The controller and/or the component application can install firmware from the firmware package following a first order to modify each corresponding active firmware and determine after each firmware installation whether the corresponding active firmware was successfully modified at 510. After each firmware from the firmware package is installed, the controller and/or the component application can access a status log and update an entry of the status log corresponding to the modified active firmware.

If the corresponding active firmware was successfully modified, the controller and/or the component application can update the corresponding entry to indicate that the firmware was successfully installed and the corresponding active firmware was successfully modified. In another embodiment, if the corresponding active firmware was not successfully modified, the controller and/or the component application can update the corresponding entry to indicate that the firmware was not successfully installed and the corresponding active firmware was not successfully modified. If any active firmware from the computing device is not successfully modified, the controller and/or the component application can proceed to uninstall each firmware from the firmware package following a second order opposite of the first order such that each active firmware of the computing device is restored at 520. The method is then complete. In other embodiments, the method of FIG. 5 includes additional steps in addition to and/or in lieu of those depicted in FIG. 5.

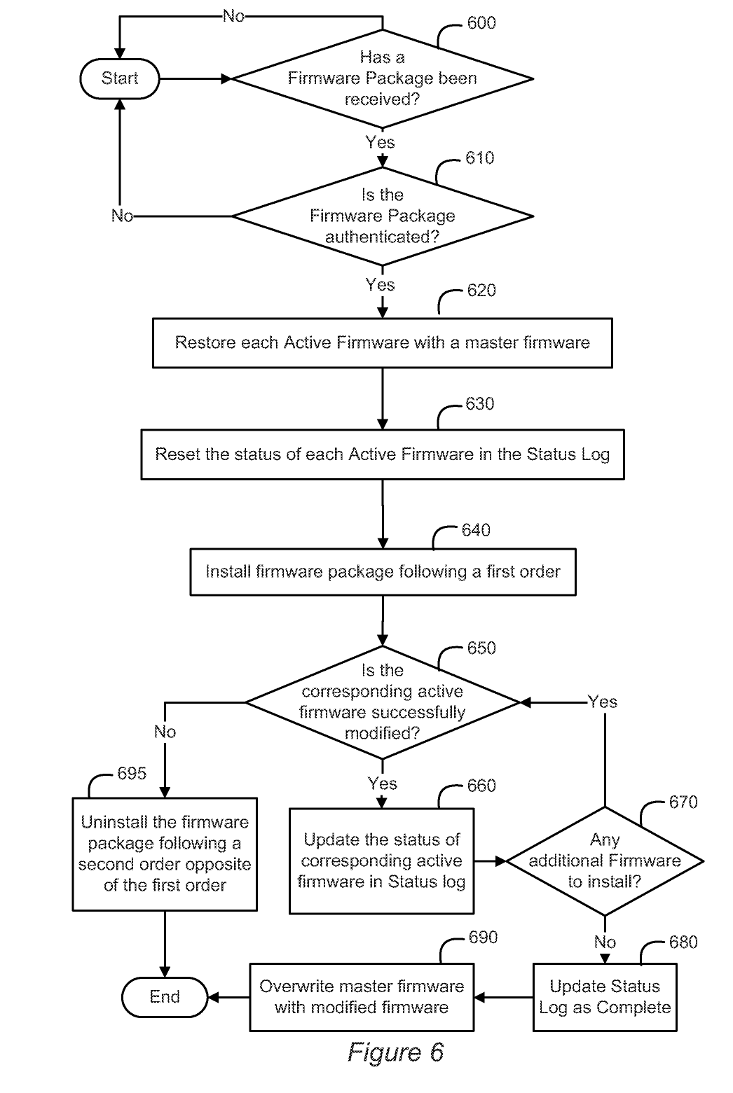

FIG. 6 is a flow chart illustrating a method for managing a computing device according to another example. The controller and/or the component application can initially determine whether a firmware package has been received at 600. If no firmware package is received, the controller and/or the component application continue to detect for a firmware package at 600. If a firmware package is received, the controller and/or the component application determine if the firmware package is authenticated by accessing a white list of authorized signatures of firmware packages and/or authorized identities of a second computing device at 610. If the firmware package is not authenticated, the controller and/or the component application discard the firmware package and continue to detect for a firmware package at 600.

If the firmware package is authenticated, the controller and/or the firmware package can store the firmware package on a second portion of a non-volatile storage component. In one embodiment, a security component hides the second portion from the controller and/or the component application until a firmware update request has been initiated by the controller and/or the component application. If the firmware update request is detected, the security component can enable a controller and/or processor controlling the second portion to make it visible to the controller and/or the component application.

The controller and/or the component application can then restore each active firmware of the computing device with master firmware from the second portion at 620. The controller and/or the component application also access a status log on the second portion and reset the status of each active firmware at 630. The controller and/or the component application can then install each firmware from the firmware package following a first order at 640. After each firmware is installed, the controller and/or the component application determine if the corresponding firmware was successfully modified by querying the component or running a diagnostic test on the component at 650.

If the active firmware was successfully modified, the status log is updated to indicate that the active firmware was successfully modified at 660. The controller and/or the component application determine if there is any additional firmware from the firmware package to install at 670. If there is additional firmware to install, the controller and/or the component application install the firmware, determine if the corresponding active firmware was successfully modified and update the status log accordingly. If there is no additional firmware to install, the status log can be updated as complete at 680. Additionally, the master firmware can be overwritten with the current active firmware at 690.

In another embodiment, if the controller and/or the component application previously determined that the corresponding active firmware was not successfully modified, the controller and/or the component application can uninstall the firmware package following a second order, opposite to the first order, to restore the active firmware of the computing device at 695. The method is then complete. In other embodiments, the method of FIG. 6 includes additional steps in addition to and/or in lieu of those depicted in FIG. 6.

What is claimed is:

1. A computing device comprising:
a non-volatile storage component with a first portion and a second portion;
wherein the first portion includes active firmware for components of the computing device and the second portion includes a firmware package to modify the active firmware; and
a controller to install firmware from the firmware package and determine if the firmware is successfully installed before proceeding to install subsequent firmware from the firmware package;
wherein the controller uninstalls the firmware package to restore the active firmware if a firmware from the firmware package fails to install.

2. The computing device of claim 1 wherein the second portion of the non-volatile storage component includes at least one of master firmware corresponding to the active firmware and a master version of an embedded operating system of the computing device.

3. The computing device of claim 1 wherein the second portion of the non-volatile storage component includes a status log to track a status of active firmware to be modified by the firmware package.

4. The computing device of claim 1 further comprising a communication component to receive the firmware package from a second computing device.

5. The computing device of claim 1 further comprising a security component to authenticate the firmware package.

6. The computing device of claim 5 wherein the security component hides the second portion of the non-volatile memory from the controller if the firmware package has not been authenticated.

7. The computing device of claim 5 wherein the security component makes the second portion of the non-volatile memory visible to the controller if the firmware package is authenticated.

8. A method for managing a computing device comprising:
retrieving a firmware package from a second portion of a non-volatile storage component;
wherein a first portion of the non-volatile storage component includes active firmware for components of the computing device;
installing the firmware package following a first order to modify the active firmware and determining whether the active firmware is successfully modified; and
uninstalling the firmware package following a second order opposite of the first order to restore the active firmware if an active firmware is not successfully modified.

9. The method for managing a computing device of claim 8 further comprising accessing a status log from the second portion of the non-volatile storage to identify a status of each active firmware on the computing device.

10. The method for managing a computing device of claim 9 further comprising resetting the status of each active firmware on the status log before installing the firmware package.

11. The method for managing a computing device of claim 10 further comprising updating the status of each active firmware on the status log as the corresponding active firmware is modified with the firmware package.

12. The method for managing a computing device of claim 10 wherein resetting the status of each active firmware on the status log includes installing master firmware from the second portion of the non-volatile memory component to modify the active firmware.

13. The method for managing a computing device of claim 12 wherein resetting the status of each active firmware on the log file includes using a master version of an embedded operating system to roll back the embedded operating system.

14. A computer readable medium comprising instructions that if executed cause a controller to:
retrieve a firmware package from a second portion of a non-volatile storage component, wherein a first portion of the non-volatile storage component includes active firmware for components of a computing device;
installing each firmware from the firmware package following a first order to modify the active firmware;
determine after installing each firmware whether each corresponding active firmware is successfully modified; and
uninstall the firmware package following a second order opposite of the first order to restore the active firmware if any active firmware is not successfully modified.

15. The computer readable medium comprising instructions of claim 14 wherein the controller overwrites master firmware with modified active firmware if each firmware from the firmware package is successfully installed.
